(19) United States
(12) Patent Application Publication
(10) Pub. No.: US 2026/0130826 A1
(43) Pub. Date: May 14, 2026

(54) MEDICAL REHYDRATION SYSTEM

(71) Applicant: University of Louisville Research Foundation, Inc., Louisville, KY (US)

(72) Inventors: George M. Pantalos, Louisville, KY (US); Chinyere C. Obioha, Marietta, GA (US); Marco A. Munoz, Louisville, KY (US); Sophie A. Wegenast, Louisville, KY (US)

(21) Appl. No.: 19/383,131

(22) Filed: Nov. 7, 2025

Related U.S. Application Data
(60) Provisional application No. 63/718,179, filed on Nov. 8, 2024.

(51) Int. Cl. A61J 1/20; A61J 1/10; A61J 1/16

(52) U.S. Cl. CPC A61J 1/2093; A61J 1/10; A61J 1/16

(57) ABSTRACT

A medical rehydration system includes a securing device for securing and compressing a bags including an internal chamber, the securing device including a base, a retention portion including a recessed channel, at least one side rail, and a compression plate rotatably attached to the at least one side rail. When a bag including an internal chamber is positioned at least partially within the recessed channel, the compression plate is rotatable between a first position wherein the compression plate contacts the bag and a second position wherein the compression plate does not contact the bag. When in the first position, a user may exert pressure on the compression plate, compressing the bag and internal chamber between the compression plate and the retention portion. In some embodiments, the medical rehydration system further includes an automated compression system for exerting pressure against the compression plate of the securing device.

### CROSS-REFERENCE TO RELATED APPLICATION

This application claims the benefit of priority to U.S. provisional patent application Ser. No. 63/718,179, filed Nov. 8, 2024, for MEDICAL REHYDRATION SYSTEM, incorporated herein by reference.

### GOVERNMENT SUPPORT

This invention was made with government support under grant number 80NSSC23K0855 awarded by the National Aeronautics and Space Administration. The government has certain rights in the invention.

### FIELD OF THE INVENTION

A medical rehydration system includes a securing device for securing and compressing a bag including an internal chamber, the securing device including a base, a retention portion including a recessed channel, at least one side rail, and a compression plate rotatably attached to the at least one side rail. When a bag including an internal chamber is positioned at least partially within the recessed channel, the compression plate is rotatable between a first position wherein the compression plate contacts the bag and a second position wherein the compression plate does not contact the bag. When in the first position, a user may exert pressure on the compression plate, compressing the bag and internal chamber between the compression plate and the retention portion. In some embodiments, the medical rehydration system further includes an automated compression system for exerting pressure against the compression plate of the securing device.

### BACKGROUND OF THE INVENTION

There is a need for long-term preservation of red blood cells for transfusion therapy and other purposes. One method of preservation includes the production of dehydrated red blood cells (dRBC) that can be stored at room temperature then rapidly rehydrated for immediate transfusion into a patient. Traditional storage methods for liquid blood samples require refrigeration and the samples remain viable for approximately 40 days. In comparison, dRBCs remain viable for approximately four years or longer and may be stored at room temperature. In some instances, a sealed, dual-chambered bag is used to store the dRBC, with a rehydration solution stored in a first chamber, the dRBCs stored in a second chamber, a seal separating the first and second chambers, and a sealable tube extends from the first chamber opposite the second chamber. When rehydration of the dRBC is desired, pressure is applied to the first chamber, rupturing the seal between the first and second chambers, and allowing the rehydration solution and dRBCs to mix. Upon rehydration, the RBCs can then be extracted from the bag via the tube and used for transfusion therapy or other purposes.

When rehydrating dRBCs in a dual-chambered bag, a user must hold the bag securely while compressing the first chamber to apply sufficient pressure to rupture the seal between chambers. Also, once the seal has been ruptured and the first and second chambers combine to form a single joint chamber, the joint chamber is preferably subjected to repeated application and release of pressure to facilitate mixing of the dRBCs and rehydration solution. Such bags are flexible and require significant compression to rupture the seal, which may be difficult to achieve manually or in some circumstances manual compression may not be an option. Accordingly, a user may place the bag against a solid surface and compress the first chamber against the solid surface to rupture the seal. Such a solid surface may not be readily available and flexible bags may slide against the surface rather than compress when pressure is applied. Accordingly, a need exists for a device for securing dual-chamber blood bags and facilitating application of pressure to rupture the seal between chambers. This need is particularly prevalent in extreme environments for carrying out transfusion therapy, such as during combat casualty care, where a hygienic solid surface may not be available, or in a microgravity environment, where manually pressing the bag against the surface may cause the user to float away from the surface.

### SUMMARY

The present invention addresses this need by providing medical rehydration system for securing and compressing dual-chambered blood bags. In some embodiments, the present invention is a medical rehydration system for use with a bag including a first chamber and a second chamber, the first chamber and second chamber separated by a seal, the medical rehydration system comprising: a securing device including a base including a left side, a right side opposite the left side, a front end, a rear end opposite the front end, a top, a bottom, and a midline extending equidistant between the left side and the right side; a retention portion extending upwardly from the base, the retention portion including a top left surface, a top right surface and a recessed channel extending along the midline; at least one side rail extending upwardly from the base; and a compression plate rotatably attached to the at least one side rail, the compression plate configured to transition between a first position and a second position, wherein, when the bag is positioned at least partially in the recessed channel, the compression plate contacts the bag aligned with the first chamber when the compression plate is in the first position and the compression plate does not contact the bag when the compression plate is in the second position. In further embodiments, the medical rehydration system further includes an automated compression system including a platform including an upper surface, wherein the bottom of the base of the securing device is attached to the upper surface of the platform; spaced apart first and second support struts extending from the upper surface of the platform; a motor carried on the first support strut; a shaft operatively engaged to the motor, the shaft extending from the motor carried on the first support strut to the second support strut, the shaft extending parallel to the midline of the securing device attached to the platform; and first and second eccentric cams carried on the shaft, wherein, when the bag is positioned at least partially in the recessed channel, the first eccentric cam is aligned with the compression plate and with the first chamber and the second eccentric cam is aligned with the second chamber, the compression plate being positioned between the first eccentric cam and the first chamber.

In other embodiments, the present invention is a method for mixing the contents of a bag including a first chamber and a second chamber, the first chamber and second chamber separated by a seal, wherein a first material is contained within the first chamber and a second material is contained within the second chamber, the method comprising: providing a medical rehydration system as described above; securing the bag to the securing device, wherein the compression plate is aligned with the first chamber; moving the compression plate to the first position such that the compression plate contacts the first chamber; and applying sufficient pressure to the compression plate to rupture the seal between the first chamber and the second chamber.

In yet other embodiments, the present invention is a method for mixing the contents of a bag including a first chamber and a second chamber, the first chamber and second chamber separated by a seal, wherein a first material is contained within the first chamber and a second material is contained within the second chamber, the method comprising: providing a medical rehydration system including a securing device and an automated compression system as described above; securing the bag to the securing device, wherein the first eccentric cam and compression plate are aligned with the first chamber and the second eccentric cam is aligned with the second chamber, the compression plate being positioned between the first eccentric cam and the first chamber; and activating the motor, causing the shaft to rotate and the first eccentric cam to apply sufficient pressure to the compression plate to rupture the seal between the first chamber and the second chamber.

It will be appreciated that the various systems and methods described in this summary section, as well as elsewhere in this application, can be expressed as a large number of different combinations and subcombinations. All such useful, novel, and inventive combinations and subcombinations are contemplated herein, it being recognized that the explicit expression of each of these combinations is unnecessary.

### BRIEF DESCRIPTION OF THE DRAWINGS

A better understanding of the present invention will be had upon reference to the following description in conjunction with the accompanying drawings.

FIG. 1A depicts a top view of a first embodiment of a securing device.

FIG. 1B depicts a right side view of the securing device of FIG. 1A.

FIG. 1C depicts a rear end view of the securing device of FIG. 1A.

FIG. 1D depicts a top right perspective view of the securing device of FIG. 1A.

FIG. 2 depicts a top view of the securing device according to the first embodiment with a dual-chambered blood bag attached thereto.

FIG. 3A depicts a top view of a second embodiment of a securing device.

FIG. 3B depicts a left side view of the securing device of FIG. 3A.

FIG. 3C depicts a rear end view of the securing device of FIG. 3A.

FIG. 3D depicts a top right perspective view of the securing device of FIG. 3A.

FIG. 4A depicts a top view of a medical rehydration system including the first embodiment of the securing device and an automated compression system.

FIG. 4B depicts a right side view of the medical rehydration system of FIG. 4A.

FIG. 4C depicts a top right perspective view of the medical rehydration system of FIG. 4A.

### DETAILED DESCRIPTION OF THE PREFERRED EMBODIMENTS

The details of one or more embodiments of the presently-disclosed subject matter are set forth in this document. Modifications to embodiments described in this document, and other embodiments, will be evident to those of ordinary skill in the art after a study of the information provided in this document. The information provided in this document, and particularly the specific details of the described exemplary embodiments, is provided primarily for clearness of understanding and no unnecessary limitations are to be understood therefrom. In case of conflict, the specification of this document, including definitions, will control.

Unless defined otherwise, all technical and scientific terms used herein have the same meaning as commonly understood by one of ordinary skill in the art to which the presently-disclosed subject matter belongs. Although any methods, devices, and materials similar or equivalent to those described herein can be used in the practice or testing of the presently-disclosed subject matter, representative methods, devices, and materials are now described.

Following long-standing patent law convention, the terms “a”, “an”, and “the” refer to “one or more” when used in this application, including the claims. Thus, for example, reference to “a cell” includes a plurality of such cells, and so forth.

Unless otherwise indicated, all numbers expressing quantities of ingredients, properties such as reaction conditions, and so forth used in the specification and claims are to be understood as being modified in all instances by the term “about.” Accordingly, unless indicated to the contrary, the numerical parameters set forth in this specification and claims are approximations that can vary depending upon the desired properties sought to be obtained by the presently-disclosed subject matter. As used herein, the term “about,” when referring to a value or to an amount is meant to encompass variations of +10% of the most precise digit in the value or amount (e.g., “about 1” refers to 0.9 to 1.1, “about 1.1” refers to 1.09 to 1.11, etc.). The term “substantially,” when modifying a term associated with a number, has the same meaning as “about” (e.g., “substantially perpendicular” to an element means an orientation with +10% of 90 degrees with respect to that element).

As used herein, ranges can be expressed as from “about” one particular value, and/or to “about” another particular value. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

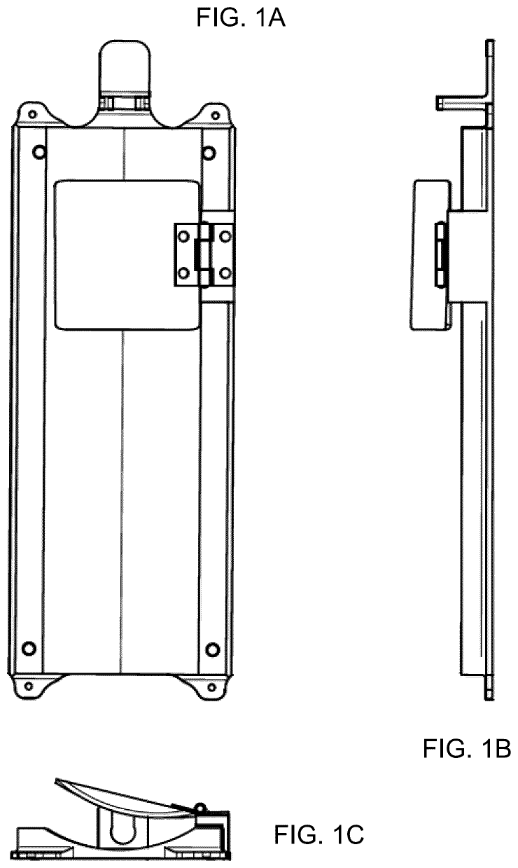

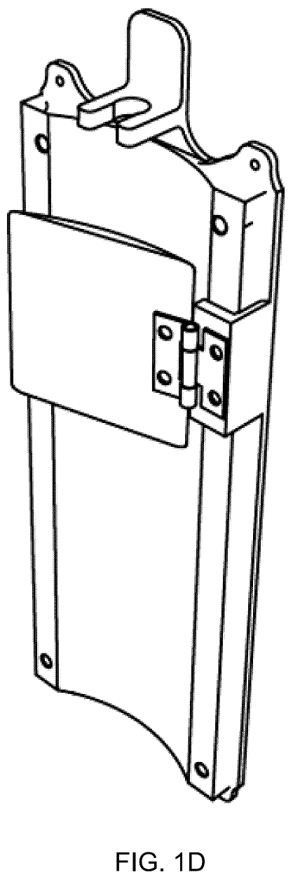

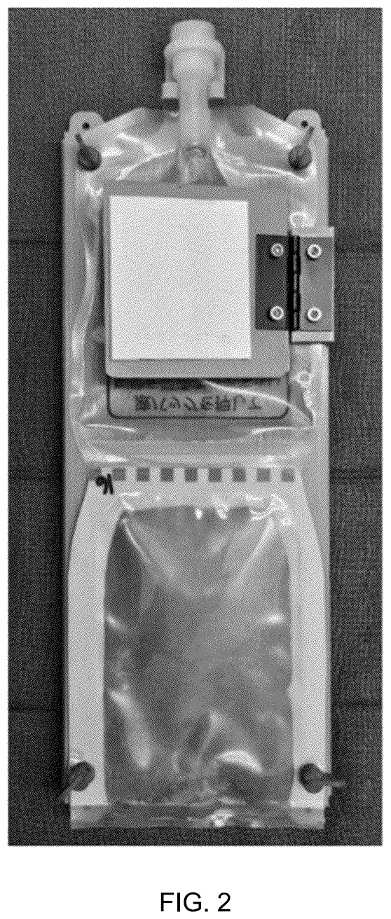

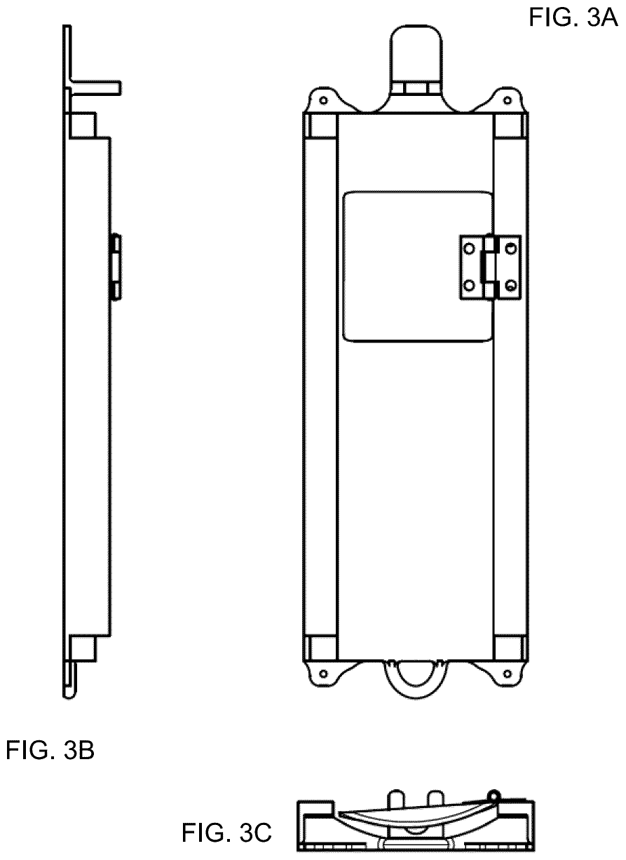

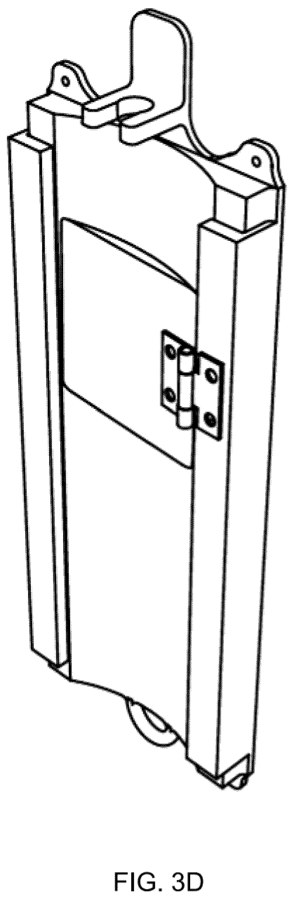

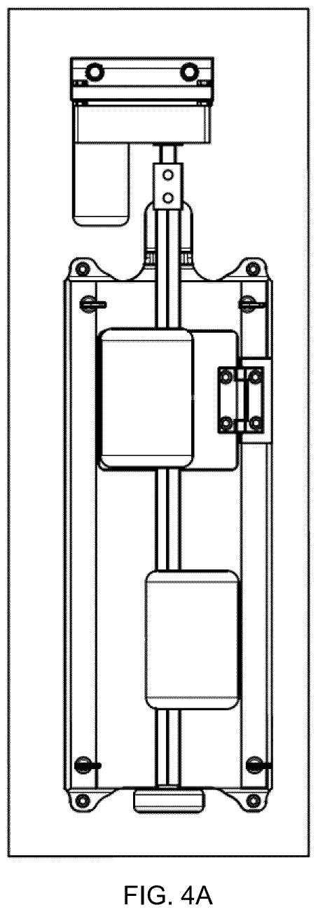

The presently-disclosed subject matter relates to a medical rehydration system 10 for use with a dual-chambered bag 12. A dual-chambered bag 12, such as, for example, a dual-chambered blood bag, includes a first internal chamber 14, a second internal chamber 16, a seal 18 separating the first chamber 14 and the second chamber 16, and a sealable tube 20 extending from the first chamber 14 opposite the second chamber 16. The medical rehydration system 10 includes a securing device 22 for securing a dual-chambered bag 12. A first embodiment of the securing device 22 as shown in FIGS. 1A-1D and FIG. 2 and a second embodiment 122 as shown in FIGS. 3A-3D each include a generally rectangular base 24 including a top 26, bottom 28, left side 30, right side 32, front end 34, and rear end 36. The left side 30 and right side 32 extend substantially parallel to each other, and the front end 34 and rear end 36 extend substantially parallel to each other. For purposes of orientation, the direction between the front end 34 and rear end 36 is referred to as the length, the direction between the left side 30 and right side 32 is referred to as the width, the direction between the top 26 and bottom 28 is referred to as the height, and a midline 38 of the securing device 22, 122 extends along the length equidistant between the left side 30 and right side 32.

The bottom 28 of the base 24 is substantially flat. The top 26 of the base 24 includes a raised retention portion 40. The retention portion 40 extends from the front end 34 to the rear end 36 and has a width less than the width of the base 24. The top of the retention portion 40 includes a left top surface 42 extending from the front end 34 to the rear end 36, a right top surface 44 extending from the front end 34 to the rear end 36, the top left surface 42 and top right surface 44 each being substantially parallel to the bottom 28. The retention portion 40 further includes a curved recess extending between the left top surface 42 and the right top surface 44, forming a recessed channel 46 extending along the midline 38 of the securing device 22, 122.

The base 24 further includes a neck portion 48 extending from the front end 34 along the midline 38 and parallel to the bottom 28. A clasp 50 extends substantially perpendicular to the neck portion 48 and is sized to receive the tube of a dual-chambered bag 12.

The base 24 further includes a plurality of flanges 52. In the depicted embodiments, the base 24 includes four flanges 52, one located on the front end 34 adjacent to the left side 30, one located on the front end 34 adjacent to the right side 32, one located on the rear end 36 adjacent to the left side 30, and one located on the rear end 36 adjacent the right side 32. Each flange 52 includes a bore 54 extending therethrough from the top to the bottom. Optionally, fasteners, such as, for example, nails, screws, or pins, (not shown) may be inserted through the bore 54 in each flange 52 to secure the device to a wall, table, or other surface, or to secure the device to an automated compression system 72 as described below.

Referring specifically to the first embodiment shown in FIGS. 1A-1D and 2, the device further includes a side rail 56 extending from the top 26 of the base 24 adjacent the right side 32 and overlying a portion of the right top surface 44, with a gap 58 between the side rail 56 and the right top surface 44. A compression plate 60 is attached to the side rail 56 via a hinge 62 or other attachment means allowing rotational movement between the attached components. The compression plate 60 includes a flat upper surface 64 to which the hinge 62 attaches and a convex lower surface 66 corresponding to the concave shape of the recessed channel 46. The compression plate 60 is rotatable between a first position where the lower surface 66 is located at least partially within the recessed channel 46 and a second position where the compression plate 60 does not occlude the recessed channel.

The first embodiment of the securing device 22 further includes at least one cavity 68 extending into the left top surface 42 and at least one cavity 68 extending into the right top surface 44. In the depicted first embodiment, the securing device 22 includes two cavities 68 in the left top surface 42, one in proximity to the front end 34 and the other in proximity to the rear end 36, and includes two cavities 68 in the right top surface 44, one in proximity to the front end 34 and the other in proximity to the rear end 36. While this embodiment shows a total of four cavities 68, with two in the left top surface 42 and two in the right top surface 44, other embodiments may include one cavity 68 per top surface 42,44, three cavities 68 per top surface 42, 44, or other configurations. In some embodiments, the at least one cavity 68 may extend partially through the securing device 22 while in other embodiments the at least one cavity 68 may extend from the top surface 42, 44 to the bottom 28.

In use, as shown in FIG. 2, the securing device 22 receives at least a portion of a dual-chambered bag 12 in the recessed channel 46 while the sides of the bag 12 lay atop the left top surface 42 and the right top surface 44. A portion of the right side of the bag 12 is received within the gap 58 between the right top surface 44 and the side rail 56. Pegs or other fasteners 70 are inserted through corners of the bag 12, but not through the first chamber 14 or second chamber 16, and into the cavities 68 in the left top surface 42 and into the cavities 68 in the right top surface 44, mechanically securing the bag 12 to the securing device 22. The tube 20 of the bag 12 is received by the clasp 50. Collectively, the clasp 50 and fasteners 70 mechanically secure the bag 12 to the securing device 22. To facilitate rehydration, the compression plate 60 is rotated from the second position to the first position to contact the bag 12 aligned with the first chamber 14. A user may then press on the compression plate 60, compressing the first chamber 14 between the compression plate 60 and the recessed channel 46 of the retention portion 40, such that the increase in pressure causes the seal 18 between the chambers 14, 16 to rupture, causing the contents of the first chamber 14 and second chamber 16 to mix. In embodiments, where the dual-chambered bag 12 is a dual-chambered blood bag, rupturing the seal 18 mixes the rehydration solution in the second chamber 16 and dRBCs in the first chamber 14.

In one embodiment, the base 24 is about 11.0 inches long, about 4.48 inches wide, and about 0.12 inches tall. The retention portion 40 extends about 0.51 inches above the base 24 at top left surface 42 and the top right surface 44, and curves downward to extend about 0.06 inches above the base 24 at the lowest point of the recessed channel 46 along the midline 38. Each of the top left surface 42, top right surface 44, and recessed channel 46 are about 11.0 inches long, extending along substantially the entire length of the base 24. The top left surface 42 and top right surface 44 are each about 0.55 inches wide and the recessed channel 46 is about 3.14 inches wide, such that the total width of the retention portion 40 is about 4.24 inches. The neck portion 48 is about 1.0 inches wide, about 0.12 inches tall, and extends about 1.75 inches from the front end 34. The clasp 50 extends upwards about 1.0 inches from the neck portion 48, is about 0.25 inches long, and includes a saddle-shaped clasp 50 with a recess about 0.45 inches wide to receive the tube 20 of a dual-chambered bag 12. The side rail 56 is about 1.84 inches long and extends upwards about 0.91 inches from the bottom 28. The horizontal portion of the side rail 56 is about 0.67 inches wide and about 0.21 inches thick, thus leaving a gap 58 of about 0.06 inches between the horizontal portion of the side rail 56 and the top right surface 44. The compression plate 60 is about 2.92 inches wide and about 3.0 inches long. The convex lower surface 66 of the compression plate 60 has the shape of a segment of a cylinder with a radius of 3.22 inches. Each flange 52 is about 0.12 inches tall and extends about 0.5 inches from the front end 34 or rear end 36, respectively, and includes a bore 54 about 0.13 inches in diameter. The cavities 68 in the top left surface 42 and top right surface 44 are each about 0.26 inches in diameter.

Referring now to the second embodiment of the securing device 122 shown in FIGS. 3A-3D, the securing device 122 is similar to the securing device 22 of the first embodiment, including a similar base 24, top 26, bottom 28, left side 30, right side 32, front end 34, and rear end 36, midline 38, raised retention portion 40, left top surface 42, right top surface 44, recessed channel 46, neck portion 48, clasp 50, flanges 52, bores, 54, compression plate 60, hinge 62, upper surface 64, and lower surface 66. The second embodiment of the securing device 122 differs from the first embodiment of the securing device 22 by including a right side rail 156 extending from the top 26 of the base 24 adjacent the right side 32 and overlying at least a portion of the right top surface 44, with a gap 158 between the right side rail 156 and the right top surface 44. The securing device 122 further includes a left side rail 168 extending from the top 26 of the base 24 adjacent the left side 30 and overlying at least a portion of the left top surface 42, with a gap 158 between the left side rail 168 and the left top surface 42. A compression plate 60 is attached to the right side rail 156 via a hinge 62 or other fastener allowing rotational movement between the attached components. In other embodiments, the compression plate 60 may be attached to the left side rail 168. The compression plate 60 is rotatable between a first position where it is located at least partially within the recessed channel 46 and a second position where it does not occlude the recessed channel 46. The base 24 further includes a loop 169 extending from the rear end 36 and substantially co-planar with the base 24.

In use, the second embodiment of the securing device 122 receives at least a portion of a dual-chambered bag 12 in the recessed channel 46 while the sides of the bag 12 lay atop the left top surface 42 and the right top surface 44. The bag 12 is slid into the recessed channel 46 from the rear end 36 toward the front end 34, with the sides of the blood bag 12 received within the respective gaps 158 between the right top surface 44 and the right side rail 156 and between the left top surface 42 and the left side rail 168. After sliding the bag 12 into the securing device 122, the tube 20 of the bag 12 is received by the clasp 50. Collectively, the clasp 50 and left and right side rails 156, 168 mechanically secure the bag 12 to the securing device 122. To facilitate rehydration, the compression plate 60 is rotated from the second position to the first position to contact the bag 12 aligned with the first chamber 14. A user may then press on the compression plate 60, compressing the first chamber 14 between the compression plate 60 and the recessed channel 46 of the retention portion 40, such that the increase in pressure causes the seal 18 between the chambers 14, 16 to rupture, causing the contents of the first chamber 14 and second chamber 16 to mix. In embodiments where the dual-chambered bag 12 is a dual-chambered blood bag, rupturing the seal 18 mixes the rehydration solution in the second chamber 16 and dRBCs in the first chamber 14. To facilitate transfusion therapy, the securing device 122 and attached bag 12 may be hung from a standard medical IV pole by the loop 169. While hung in this orientation, the rear end 36 and loop 169 are oriented upwards and the front end 34 and tube 20 are oriented downwards, such that gravity facilitates RBC exit from the bag 12.

In one embodiment, the dimensions of the second embodiment of the securing device 122 are the same as the dimensions of the first embodiment of the securing device 22, apart from right side rail 156 and the left side rail 168, the lack of cavities 68 in the top left surface 42 and top right surface 44, and the inclusion of the loop 169 on the rear end 36. In the second embodiment of the securing device 122, the right side rail 156 and left side rail 168 are each about 10.0 inches long, terminating about 0.5 inches from the front end 34 and 0.5 inches from the rear end 36, and extend upwards about 0.91 inches from the bottom 28. The horizontal portion of each side rail 156, 168 is about 0.67 inches wide and about 0.21 inches thick, thus leaving a gap 158 of about 0.06 inches between the horizontal portion of each side rail 156, 168 at the respective top surface 42, 44. The loop 169 on the rear end is about 0.25 inches thick, with an outer diameter of about 1.24 inches and an inner diameter of about 0.73 inches.

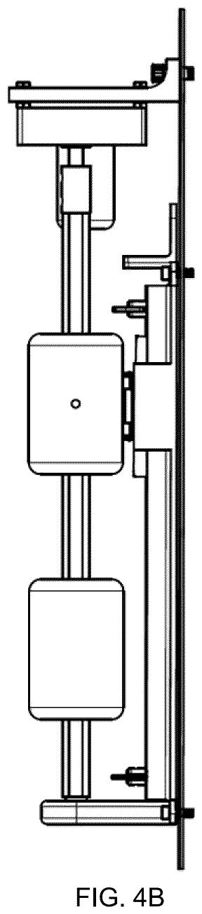

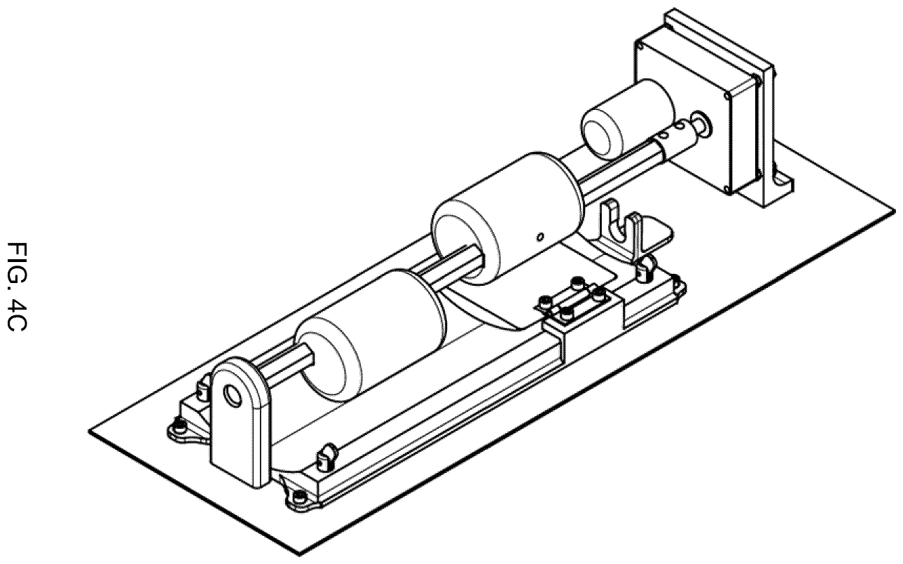

Referring now to FIGS. 4A-4C, in some embodiments, the medical rehydration device 10 includes an optional automated compression system 72 used in conjunction with the securing device 22. The automated compression system 72 includes a substantially flat platform 74. The bottom 28 of the base 24 of the securing device 22 is mechanically attached to the platform 74 via fasteners 76 inserted through the bores 54 in the flanges 52 of the securing device 22 and into or through the platform 74. The automated compression system 72 includes spaced apart first and second support struts 78, 80 extending substantially perpendicular to the platform 74. A motor 82, such as an electric motor, is carried by the first support strut 78. A rotatable shaft 84 operatively engages the motor 82 and extends to and is supported by the second support strut 80, the shaft extending substantially parallel to the midline 38 of the securing device 22. The shaft carries a first and second eccentric cams 86, 88, the first eccentric cam 86 aligned with the compression plate 60 and first chamber and the second eccentric cam 88 aligned with the second chamber (bag not shown in FIGS. 4A-4C). In a preferred embodiment, the first and second eccentric cams 86, 88 are oriented about 180 degrees from each other, such that when one cam is in a downward orientation the other cam is in an upward orientation.

In use, a dual-chambered bag (not shown in FIGS. 4A-4C) is received and carried by the securing device 22 as described above. The motor 82 is then activated, causing the shaft 84 to rotate. As the shaft 84 rotates, the first eccentric cam 86 repeatedly presses against the compression plate 60 and the second eccentric cam 88 repeatedly presses against the second chamber. As the first and second eccentric cams 86, 88 are oriented about 180 degrees from each other, when the first cam 86 is pressing against the compression plate 60, the second cam 88 is oriented away from and is not pressing against the second chamber. Likewise, when the second cam 88 is pressing against the second chamber, the first cam 86 is oriented away from the compression plate 60. The first eccentric cam 86 pressing against the compression plate 60 compresses the first chamber, causing the seal between the first and second chambers to rupture and the contents of the first and second chambers to mix. As the shaft 84 continues to rotate, the cams 86, 88 alternatively compress the first and second chambers, promoting mixing of the contents of the chambers.

After the contents of the chambers have been suitably mixed, the current bag may be removed from the medical rehydration device 10 and a new bag added to the device 10. To remove the current bag, the fasteners 70 extending through the bag and into the at least one cavity in the left top surface 40 and into the at least one cavity in the right top surface 42 are withdrawn, removing the mechanical connection between the bag and the securing device 22. The tube of the bag is then removed from the clasp 50. Then, the shaft 84 is rotated such that the maximum diameter of each eccentric cam 86, 88 is oriented horizontally, that is, perpendicular to the securing device 22, as shown in FIGS. 4A-4C, to maximize the clearance between the securing device 22 and the cams 86, 88. The removal of the fasteners 70, removal from the tube from the clasp 50, and rotation of the shaft 84 can be performed in any order. This configuration allows the current bag to be slid to the left (from the perspective shown in FIG. 4A) and removed from the medical rehydration device 10. A new bag with an intact seal can then be slid left-to-right onto the securing device 22 and beneath the shaft 84, such that a portion of the right side of the new bag is received within the gap 58 between the right top surface 44 and the side rail 56. Fasteners 70 are inserted through the corners of the bag, but not the first chamber or second chamber, and into the at least one cavity 68 in the left top surface 42 and into the at least one cavity 68 in the right top surface 44, mechanically securing the bag to the securing device 22. The tube of the blood bag is received by the clasp 50. The new bag is now secured to the medical rehydration device 10 and the medical rehydration device 10 is ready for activation.

In some embodiments, the motor 82 of the automated compression system 72 is battery-powered using, for example, a 12V 1.3 A battery or 12V 5 A battery. In testing, the automated compression device 72 powered by a 12V 5 A battery was capable of applying sufficient pressure to rupture the seal 18 between the first and second chambers 14, 16 of the bag 12. The pressure was measured at 441 mmHg (8.5 psi or 58.8 kPa) upon rupture.

While FIGS. 4 A-4C show the medical rehydration device 10 as including the automated compression system 72 in conjunction with the first embodiment of the securing device 22 as shown in FIGS. 1A-1D and FIG. 2, the medical rehydration device 10 may alternatively include the automated compression system 72 in conjunction with the second embodiment of the securing device 122 as shown in FIGS. 3A-3D. Use of automated compression system 72 with the securing device 122 is similar to the method as previously described, but the process of removing and replacing a bag 12 differs. After the contents of the chambers have been suitably mixed, the shaft 84 is rotated such that the maximum diameter of each eccentric cam 86, 88 is oriented horizontally. Then, the second embodiment of the securing device 122 is detached from the platform by removing the fasteners inserted through the bores 54 in the flanges 52 of the securing device 122 and into the platform 74. The securing device 122 is then slid leftwards or rightwards out from under the shaft 84. Then, the tube 20 of the bag 12 is removed from the clasp 50. Next, the bag 12 is slid in a rearward direction, removing the bag 12 from the recessed channel 46 and removing the sides of the blood bag 12 from the gaps 158 between the right top surface 44 and the right side rail 156 and between the left top surface 42 and the left side rail 168, respectively. Once the bag 12 is removed, a new bag 12 with an intact seal 18 can then be slid into the securing device 122 as previously described and the tube 20 of the new bag 12 received by the clasp 50. Collectively, the clasp 50 and left and right side rails 168, 156 mechanically secure the new bag 12 to the securing device 122. Then, the second embodiment of the securing device 122 can be placed on the platform 74, positioned beneath the shaft 84 with the shaft 84 aligned with the midline 38, and the securing device 122 attached to the platform 74 via fasteners inserted through the bores 54 and into the platform 74. The new bag 12 is now secured to the medical rehydration device 10 and the medical rehydration device 10 is ready for activation.

While the disclosed medical rehydration system is discussed primarily in terms of securing dual-chambered blood bags, the system may be used in securing dual-chambered bags with contents other than dRBC and rehydrating solutions. In another exemplary use, the system may be used in securing dual-chambered bags containing a pharmaceutical in powder form in one of the first chamber or second chamber and containing a diluent in the other of the first chamber or second chamber. In another exemplary use, the system may be used in securing dual-chambered bags containing a dehydrated therapeutic agent in one of the first chamber or second chamber and containing a rehydrating solution in the other of the first chamber or second chamber. In a further exemplary use, the system may be used for mixing solutions and not for rehydrating. In such examples, the system may be used in securing dual-chambered bags in which each chamber contains a different solution and the solutions undergo a chemical reaction or otherwise experience a change in efficacy when admixed.

At least the base 24, retention portion 40, and compression plate 60 of the securing device 22, 122 are preferably constructed of a lightweight rigid material capable of withstanding the pressure applied while rupturing the seal of a dual-chambered bag 12 without deformation.

In some embodiments, a plurality of automated compression systems 72 may be mounted on the same platform 74. Such embodiments may be particularly suited for use with mass casualty events, where it would be advantageous to rehydrate multiple blood bags simultaneously.

The foregoing detailed description is given primarily for clearness of understanding and no unnecessary limitations are to be understood therefrom for modifications can be made by those skilled in the art upon reading this disclosure and may be made without departing from the spirit of the invention.

1. A medical rehydration system for use with a bag including a first chamber and a second chamber, the first chamber and second chamber separated by a seal, the medical rehydration system comprising:
a securing device including
a base including a left side, a right side opposite the left side, a front end, a rear end opposite the front end, a top, a bottom, and a midline extending equidistant between the left side and the right side;
a retention portion extending upwardly from the base, the retention portion including a top left surface, a top right surface and a recessed channel extending along the midline;
at least one side rail extending upwardly from the base; and
a compression plate rotatably attached to the at least one side rail, the compression plate configured to transition between a first position and a second position, wherein, when the bag is positioned at least partially in the recessed channel, the compression plate contacts the bag aligned with the first chamber when the compression plate is in the first position and the compression plate does not contact the bag when the compression plate is in the second position.

2. The medical rehydration system of claim 1,
wherein the at least one side rail extends upwardly from the left side of the base, and wherein the at least one side rail overlies at least a portion of the top left surface, forming a gap between the at least one side rail and the top left surface; and
wherein, when the bag is positioned at least partially in the recessed channel, a portion of the bag is positioned within the gap.

3. The medical rehydration system of claim 1,
wherein the at least one side rail extends upwardly from the right side of the base, and wherein the at least one side rail overlies at least a portion of the top right surface, forming a gap between the at least one side rail and the top right surface; and
wherein, when the bag is positioned at least partially in the recessed channel, a portion of the bag is positioned within the gap.

4. The medical rehydration system of claim 1, wherein the base further includes a neck portion extending from the front end along the midline, and further includes a clasp extending substantially perpendicular to the neck portion, the clasp being sized to receive a tube extending from the bag.

5. The medical rehydration system of claim 1, further comprising a plurality of flanges extending from the base, each flange including a bore extending therethrough from the top to the bottom.

6. The medical rehydration system of claim 1, further comprising at least one cavity extending into the left top surface and at least one cavity extending into the right top surface.

7. The medical rehydration system of claim 1, further comprising:
an automated compression system including
a platform including an upper surface, wherein the bottom of the base of the securing device is attached to the upper surface of the platform;
spaced apart first and second support struts extending from the upper surface of the platform;
a motor carried on the first support strut;
a shaft operatively engaged to the motor, the shaft extending from the motor carried on the first support strut to the second support strut, the shaft extending parallel to the midline of the securing device attached to the platform; and
first and second eccentric cams carried on the shaft, wherein, when the bag is positioned at least partially in the recessed channel, the first eccentric cam is aligned with the compression plate and with the first chamber and the second eccentric cam is aligned with the second chamber, the compression plate being positioned between the first eccentric cam and the first chamber.

8. The medical rehydration system of claim 7, further comprising a plurality of flanges extending from the base, each flange including a bore extending therethrough from the top to the bottom, wherein the securing device is attached to the platform by inserting fasteners through the bores and into the platform.

9. A method for mixing the contents of a bag including a first chamber and a second chamber, the first chamber and second chamber separated by a seal, wherein a first material is contained within the first chamber and a second material is contained within the second chamber, the method comprising:
providing a medical rehydration system according to claim 1;
securing the bag to the securing device, wherein the compression plate is aligned with the first chamber;
moving the compression plate to the first position such that the compression plate contacts the first chamber; and
applying sufficient pressure to the compression plate to rupture the seal between the first chamber and the second chamber.

10. The method of claim 9, further comprising hanging the securing device from a support via a loop extending from the rear end of the base.

11. The method of claim 10, wherein the support is an IV pole.

12. The method of claim 9, wherein the first material is a rehydrating solution and wherein the second material is dehydrated red blood cells.

13. The method of claim 9, wherein rupturing the seal between the first chamber and the second chamber causes the first material and second material to contact each other.

14. The method of claim 13, subsequent to the applying step, repeatedly applying and releasing pressure against the compression plate to facilitate mixture of the first material and the second material.

15. The method of claim 9, wherein the base further includes a neck portion extending from the front end along the midline, and further includes a clasp extending substantially perpendicular to the neck portion, the clasp being sized to receive a tube extending from the bag; and
wherein securing the bag to the securing device includes inserting the tube into the clasp.

16. The method of claim 9, wherein the at least one side rail extends upwardly from the base and either overlies at least a portion of the top left surface, forming a gap between the at least one side rail and the top left surface, or overlies at least a portion of the top right surface, forming a gap between the at least one side rail and the top right surface; and
wherein securing the bag to the securing device includes positioning a portion of the bag within the gap.

17. The method of claim 9, wherein securing the bag to the securing device includes inserting a fastener through the bag and into at least one cavity in the left top surface and inserting a fastener through the bag and into at least one cavity in the right top surface.

18. A method for mixing the contents of a bag including a first chamber and a second chamber, the first chamber and second chamber separated by a seal, wherein a first material is contained within the first chamber and a second material is contained within the second chamber, the method comprising:
providing a medical rehydration system according to claim 7;
securing the bag to the securing device, wherein the first eccentric cam and compression plate are aligned with the first chamber and the second eccentric cam is aligned with the second chamber, the compression plate being positioned between the first eccentric cam and the first chamber; and
activating the motor, causing the shaft to rotate and the first eccentric cam to apply sufficient pressure to the compression plate to rupture the seal between the first chamber and the second chamber.

19. The method of claim 18, further comprising, subsequent to the rupture of the seal, the shaft continues to rotate, causing the first eccentric cam to repeatedly apply and release pressure against the compression plate and the second eccentric cam to repeatedly apply and release pressure against the second chamber to facilitate mixture of the first material and the second material.

20. The method of claim 18, wherein the first eccentric cam and the second eccentric cam are oriented about 180 degrees from each other.
